(19) United States
(12) Patent Application Publication
(10) Pub. No.: US 2008/0195841 A1
(43) Pub. Date: Aug. 14, 2008

(54) Driving apparatus of display device and driving method thereof

(76) Inventors: Ahn-Ho Jee, Hwaseong -si (KR); Dong-Hwan Kim, Suwon-si (KR); Dong-Hwan Lee, Yongin-si (KR); Tae-Hun Kim, Hwaseong-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/998,332

(22) Filed: Nov. 28, 2007

(30) Foreign Application Priority Data
Feb. 8, 2007 (KR) 10-2007-0013141

(51) Int. Cl. G06F 15/76; G06F 9/02

(52) U.S. Cl. 712/1; 712/E09.002

(57) ABSTRACT

Disclosed is a driving apparatus of a display device having a plurality of pixels. The driving apparatus includes a signal generator that generates a shutdown signal, first and second register units that store register values, a gate driver that transmits gate signals to the pixels, a data driver that transmits data voltages to the pixels, and a signal controller that controls the gate driver and the data driver based on the register values of the first and second register units. An initialization of the register values stored in the register units is controlled based on the shutdown signal. The first register unit and the second register unit have the same construction.

### CROSS-REFERENCE TO RELATED APPLICATION

This application claims priority to and the benefit of Korean Patent Application No. 10-2007-0013141 filed in the Korean Intellectual Property Office on Feb. 8, 2007, the entire contents of which are incorporated herein by reference.

### BACKGROUND OF THE INVENTION

(a) Field of the Invention

The present invention relates to a driving apparatus of a display device and a driving method thereof.

(b) Description of the Related Art

In general, liquid crystal displays (LCDs) include two display panels respectively having pixel electrodes and a common electrode, and a liquid crystal layer having dielectric anisotropy interposed therebetween. The pixel electrodes are arranged in a matrix and connected to switching devices such as thin film transistors (TFTs) so as to be sequentially supplied with data voltages in units of a pixel row. The common electrode is disposed over the entire surface of one display panel and is supplied with a common voltage. Alternatively, the common electrode may be formed on the same panel as that having the pixel electrodes. In terms of a circuit, a pixel electrode, the common electrode, and the liquid crystal layer interposed therebetween constitute a liquid crystal capacitor. The liquid crystal capacitor together with the switching element connected thereto becomes a unit of a pixel.

The LCD generates electric fields by applying voltages to the pixel electrodes and the common electrode, and the strength of the electric fields applied thereto are varied in order to adjust transmittance of light passing through the liquid crystal layer, thereby displaying images.

The LCD also includes switching elements each of which is connected to a pixel electrode, gate lines and data lines connected to the switching elements, a gate driver that transmits gate signals to the gate lines, a data driver that transmit data voltages to the data lines, and a control signal that controls the gate driver and the data driver.

The LCD selectively uses a plug and play (P&P) mode or a serial peripheral interface (SPI) mod e to define values of registers required for operating each element such as the gate driver, the data driver, and the signal controller.

When the SPI mode is used in the LCD, the values of the registers are defined based on data applied from an external device in synchronization with a clock signal such that the LCD operates.

When the P&P mode is used in the LCD, the values of the registers are initialized with predetermined initial values by a shutdown function signal SD in the application of the power supply, such that the LCD operates.

However, when the values of the registers are changed by, for example, electrical shock or electrostatic discharge applied from the outside, the LCD does not operate properly.

### SUMMARY OF THE INVENTION

According to an embodiment of the present invention, a driving apparatus is provided, the driving apparatus including a signal generator that generates a shutdown signal, a plurality of register units that store register values, a register value adjustor that compares the register values, and when at least one register value of the register values stored in the same address has a different value, controls a state of the shutdown signal, wherein an initialization of the register values stored in the register units is controlled based on the shutdown signal.

The signal generator may be a plug and play unit.

The register units may include a first register unit and a second register unit, and the first register unit and the second register unit have the same construction.

The register value adjustor may compare the register values stored in the same address in at least one part of the first and second register units, and when the compared register values are different, it may control the state of the shutdown signal to initialize the register values of the first and second register units.

The first and second register units may store values of a fixed register and a variable register, and the values of the fixed register are not changed, but the values of the variable register are changed.

The register units may include a first register unit that stores the values of a fixed register and a variable register, and a second register unit that stores the values of the variable register.

The register value adjustor may compare the values of the variable register of the first register unit and the values of the variable register of the second register unit.

According to another embodiment of the present invention, a driving apparatus of a display device having a plurality of pixels is provided, the driving apparatus including a signal generator that generates a shutdown signal, a plurality of register units that store register values, a gate driver that transmits gate signals to the pixels, a data driver that transmits data voltages to the pixels, and a signal controller that controls the gate driver and the data driver based on the register values of the register units, wherein an initialization of the register values stored in the register units is controlled based on the shutdown signal.

The register units may include a first register unit and a second register unit, and the first register unit and the second register unit have the same construction.

The first and second register units may store values of a fixed register and a variable register, and the values of the fixed register may be not changed, but the values of the variable register may be changed.

The register units may include a first register unit that stores the values of a fixed register and a variable register, and a second register unit that stores the values of the variable register.

The register value adjustor may compare the register values stored in the same address in at least one part of the first and second register units, and when the compared register values are different, it may control the state of the shutdown signal to initialize the register values of the first and second register units.

According to further another embodiment of the present invention, a driving method of a display device having a plug and play unit that generates a shutdown signal, and a plurality of register units is provided, the driving method including reading register values stored in at least one part of the register units, comparing the read register values stored in the same address, and changing a state of the shutdown signal when an address having different register values from each other exists, to initialize the register values of the register units with initial values.

### BRIEF DESCRIPTION OF THE DRAWINGS

An exemplary embodiment of the present invention is described below in detail with reference to the accompanying drawings wherein:

FIG. 1 is a block diagram of an LCD according to an exemplary embodiment of the present invention;

FIG. 2 is an equivalent circuit diagram of a pixel of an LCD according to an exemplary embodiment of the present invention;

FIG. 3 is a block diagram of the signal controller shown in FIG. 1;

FIG. 4 is an operation flow chart of the plug and play unit shown in FIG. 1;

FIG. 5 is an operation flow chart of the register value adjuster shown in FIG. 3; and

FIG. 6 is an example of the register units according to an exemplary embodiment of the present invention.

### DETAILED DESCRIPTION OF THE EMBODIMENTS

The present invention is described below more fully with reference to the accompanying drawings, in which exemplary embodiments of the invention are shown. As those skilled in the art realize, the described embodiments may be modified in various different ways, all without departing from the spirit or scope of the present invention.

In the drawings, the thickness of layers, films, panels, and regions are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

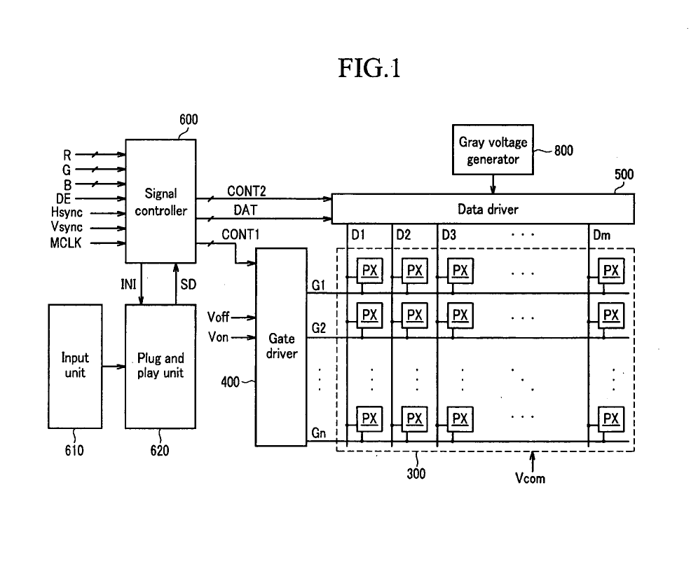

Referring to FIGS. 1, 2, and 6, an LCD according to an exemplary embodiment of the present invention is described.

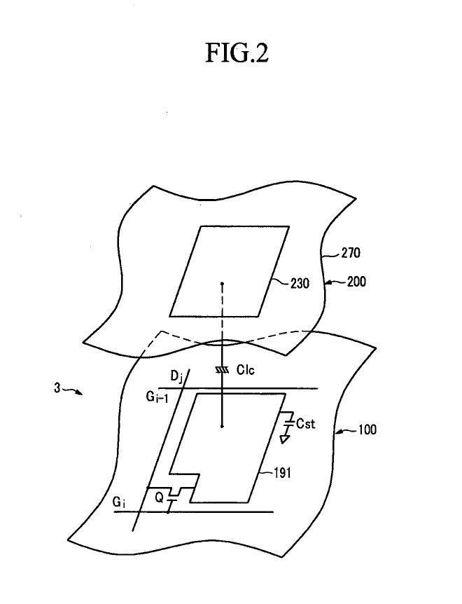

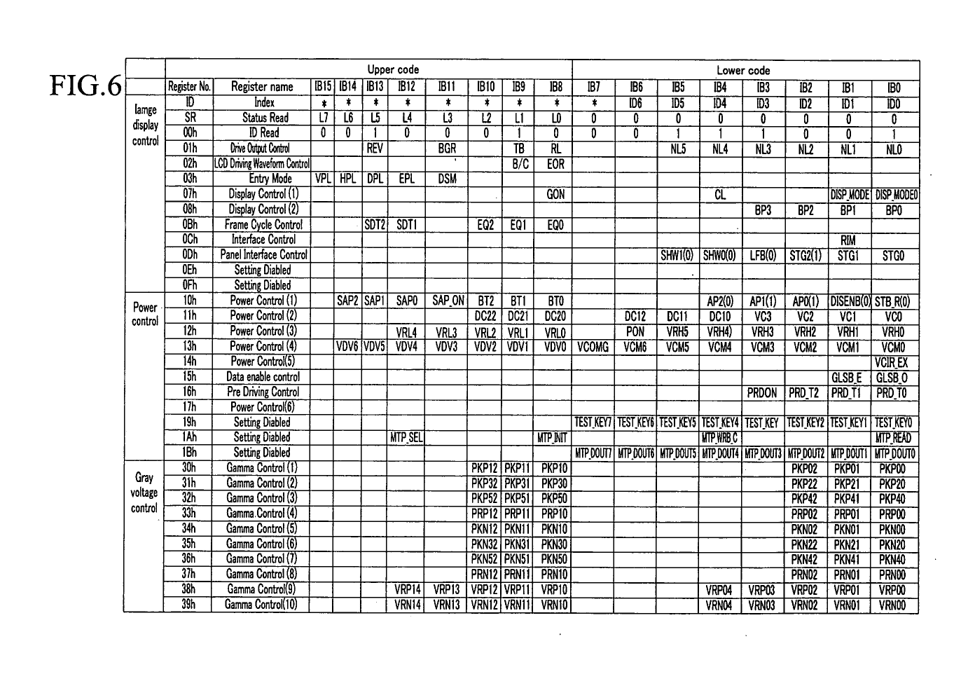

FIG. 1 is a block diagram of an LCD according to an exemplary embodiment of the present invention, and FIG. 2 is an equivalent circuit diagram of a pixel of an LCD according to an exemplary embodiment of the present invention. FIG. 6 is an example of the register units according to an exemplary embodiment of the present invention.

Referring to FIG. 1, an LCD according to an embodiment includes a liquid crystal (LC) panel assembly 300, an input unit 610, a P&P (plug and play) unit 620, a gate driver 400 and a data driver 500 that are coupled with the panel assembly 300, a gray voltage generator 800 coupled with the data driver 500, and a signal controller 600 controlling the above elements.

The panel assembly 300 includes a plurality of signal lines G₁-Gₙ and D₁-Dₘ and a plurality of pixels PX connected to the signal lines G₁-Gₙ and D₁-Dₘ and arranged substantially in a matrix. In the structural view shown in FIG. 2, the panel assembly 300 includes lower and upper panels 100 and 200 facing each other, and an LC layer 3 interposed between the panels 100 and 200.

The signal lines include a plurality of gate lines G₁-Gₙ transmitting gate signals (also referred to as “scanning signals” hereinafter) and a plurality of data lines D₁-Dₘ transmitting data voltages. The gate lines G₁-Gₙ extend substantially in a row direction and substantially parallel to each other, while the data lines D₁-Dₘ extend substantially in a column direction and substantially parallel to each other.

Referring to FIG. 2, each pixel PX, for example a pixel PX connected to the i-th gate line Gᵢ (i=1, 2, . . . , n) and the j-th data line Dⱼ (j=1, 2, . . . , m), includes a switching element Q connected to the signal lines Gᵢ and Dⱼ, and an LC capacitor Clc and a storage capacitor Cst that are connected to the switching element Q. The storage capacitor Cst may be omitted.

The switching element Q is disposed on the lower panel 100 and has three terminals, i.e., a control terminal connected to the gate line Gᵢ, an input terminal connected to the data line Dⱼ, and an output terminal connected to the LC capacitor Clc and the storage capacitor Cst.

The LC capacitor Clc includes a pixel electrode 191 disposed on the lower panel 100 and a common electrode 270 disposed on the upper panel 200 as two terminals. The LC layer 3 disposed between the two electrodes 191 and 270 functions as a dielectric of the LC capacitor Clc. The pixel electrode 191 is connected to the switching element Q, and the common electrode 270 is supplied with a common voltage Vcom and covers an entire surface of the upper panel 200. Unlike in FIG. 2, the common electrode 270 may be provided on the lower panel 100, and at least one of the electrodes 191 and 270 may have a shape of a bar or a stripe.

The storage capacitor Cst is an auxiliary capacitor for the LC capacitor Clc. The storage capacitor Cst includes the pixel electrode 191 and a separate signal line, which is provided on the lower panel 100, overlaps the pixel electrode 191 via an insulator, and is supplied with a predetermined voltage such as the common voltage Vcom. Alternatively, the storage capacitor Cst includes the pixel electrode 191 and an adjacent gate line called a previous gate line, which overlaps the pixel electrode 191 via an insulator.

For color display, each pixel uniquely represents one of primary colors (i.e., spatial division) or each pixel sequentially represents the primary colors in turn (i.e., temporal division) such that a spatial or temporal sum of the primary colors is recognized as a desired color. An example of a set of primary colors includes red, green, and blue. FIG. 2 shows an example of the spatial division in which each pixel includes a color filter 230 representing one of the primary colors in an area of the upper panel 200 facing the pixel electrode 191. Alternatively, the color filter 230 is provided on or under the pixel electrode 191 on the lower panel 100.

One or more polarizers (not shown) are attached to the panel assembly 300.

Referring to FIG. 1 again, the input unit 610 inputs desired data and other information to the LCD, and may be a keyboard, a mouse, or a control panel.

The P&P unit 620 is connected to the input unit 610, and is supplied with power supply for operating the LCD from a power source (not shown). The P&P unit 620 generates a shutdown signal SD of which level is changed to transmit to the signal controller 600. Accordingly, the P&P unit 620 may be a signal generator.

The gray voltage generator 800 generates a full number of gray voltages or a limited number of gray voltages (referred to as “reference gray voltages” hereinafter) related to the transmittance of the pixels PX. Some of the (reference) gray voltages have a positive polarity relative to the common voltage Vcom, while the other of the (reference) gray voltages have a negative polarity relative to the common voltage Vcom.

The gate driver 400 is connected to the gate lines G₁-Gₙ of the panel assembly 300, and synthesizes a gate-on voltage Von and a gate-off voltage Voff to generate the gate signals for application to the gate lines G₁-Gₙ.

The data driver 500 is connected to the data lines D₁-Dₘ of the panel assembly 300 and applies data voltages, which are selected from the gray voltages supplied from the gray voltage generator 800, to the data lines D₁-Dₘ. However, when the gray voltage generator 800 generates a few of the reference gray voltages rather than all the gray voltages, the data driver 500 may divide the reference gray voltages to generate the data voltages from among the reference gray voltages.

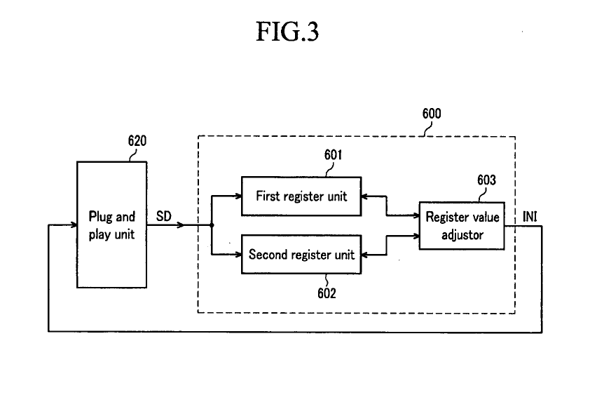

As shown in FIG. 3, the signal controller 600 includes first and second register units 601 and 602, and a register value adjuster 603. The register value adjuster 603 is connected to the first and second register units 601 and 602, and the P&P unit 620. The signal controller 600 controls the gate driver 400 and the data driver 500 based on register values of each register unit 601 and 602.

The first and second register units 601 and 602 store values for controlling the image displaying, the power supplying, and the gray voltage controlling. The construction of the first and second register units 601 and 602 is the same. An example of the register units 601 and 602 is illustrated in FIG. 6.

In FIG. 6, values stored in addresses “00h” and “0Fh” are values of registers involving the image displaying, values stored in addresses from “10h” to “1Bh” are values of registers involving the generating of a plurality of voltages, and values stored in addresses from “30h” to “39h” are values of registers involving the gray voltage generating.

The register units 601 and 602 include a plurality of resisters, respectively. The registers are divided into fixed registers connected to predetermined voltages, for example a ground voltage or about +5V through wires, and thereby having fixed values, first variable registers of which values are varied by a user, and second variable registers of which values are logically varied by signals from an external device.

In the embodiment the register units 601 and 602 are the same, and they store values of the fixed registers and the first and second variable registers. However, alternatively, one of the register units 601 and 602 may store values of the first and second variable registers.

In this embodiment, the register units 601 and 602 are included in the signal controller 600. Alternatively, the register units 601 and 602 are stored in a memory unit separate from the signal controller 600.

The register value adjuster 603 compares register values of the first and second register units 601 and 602, respectively. When at least one register having a different value exists, the register value adjuster 603 controls the P&P unit 620, to control a state of the showdown signal CD.

Each of driving devices 400, 500, 600, and 800 may include at least one integrated circuit (IC) chip mounted on the LC panel assembly 300 or on a flexible printed circuit (FPC) film in a tape carrier package (TCP) type, which are attached to the panel assembly 300. Alternatively, at least one of the driving devices 400, 500, 600, and 800 may be integrated into the panel assembly 300 along with the signal lines G₁-Gₙ and D₁-Dₘ and the switching elements Q. As a further alternative, all the driving devices 400, 500, 600, and 800 may be integrated into a single IC chip, but at least one of the driving devices 400, 500, 600, and 800 or at least one circuit element in at least one of the driving devices 400, 500, 600, and 800 may be disposed out of the single IC chip.

Below the operation of the above-described LCD is described in detail.

For operating the LCD, when a power supply is supplied from a power source, the P&P unit 620 outputs the shutdown signal SD, of which a state has a high level voltage H for a predetermined time, and then is changed to a low level voltage L.

When the state of the shutdown signal SD is changed from the high level voltage H to the low level voltage L, the signal controller 600 initializes register values of the first and second register units 601 and 602 with predetermined initial values. However, when the signal inputting through the input unit 610 does not occur for a predetermined time, the P&P unit 620 changes the state of the shutdown signal SD from the high level voltage H. Thus, the P&P unit 620 shunts down the operation of the LCD, that is, the operation of the LCD is converted to a shutdown operation mode.

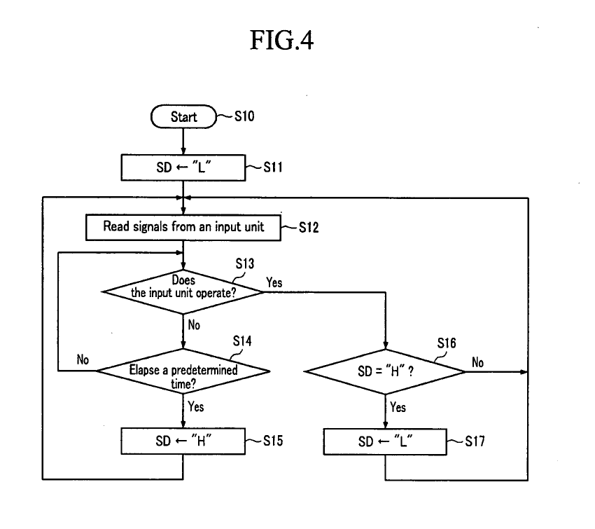

The operations of the P&P unit 620 is described below in detail with reference to FIG. 4.

When a power supply for operating the LCD is applied from an external device, and thereby the P&P unit 620 starts to operate (step S10), the P&P unit 620 changes a state of the shutdown signal SD from a high level voltage H to a low level voltage L, to transmit it to the signal controller 600. When the state of the shutdown signal SD is changed from the high level voltage H to the low level voltage L, the signal controller 600 initializes register values of the first and second register units 601 and 602 with predetermined initial values, and controls the gate driver 400 and data driver 500 to display images based on input image signals R, G, and B.

Next, the P&P unit 620 reads signals from the input unit 610, and determines whether the input unit 610 is operated (steps S12 and S13).

When the input unit 610 is not operated, the P&P unit 620 determines whether non-operation time of the input unit 610 exceeds a predetermined time (step S14).

When the non-operation time does not exceed the predetermined time, the P&P unit 620 determines whether the input section 610 is operated (step S13).

However, when the non-operation time exceeds the predetermined time, the P&P unit 620 outputs the shutdown signal SD having the high level voltage H to transmit it to signal controller 600 (step 15).

Thereby, the signal controller 600 controls a voltage generator (not shown) such that the signal controller 600 changes an operation mode of the LCD to the shutdown operation mode in which the minimum operations of the LCD are performed. Therefore, undesired power consumption of the LCD is decreased.

However, in step (S13), when the input unit 610 operates such that signals are input from the input unit 610, the P&P unit 620 determines whether the state of the shutdown signal SD is the high level voltage H, that is, the operation mode of the LCD is the shutdown operation mode (step S16).

When the state of the shutdown signal SD maintains not the high level voltage H but the low level voltage L, the P&P unit 620 goes to the step (S12) to determine the operation state of the input unit 610.

However, when the state of the shutdown signal SD maintains the high level voltage H, the P&P unit 620 changes the state of the shutdown signal SD to the low level voltage L (step 17), to convert the operation mode of the LCD from the shutdown operation mode to a normal operation mode.

Thereby, the signal controller 600 initializes register values of the first and second register units 601 and 602 with the initial value, and thus controls the LCD to normally display images.

When the register values of the first and second register units 601 and 602 are defined by the initial values in accordance with the shutdown signal SD by operating the P&P unit 620, the signal controller 600 is supplied with input image signals R, G, and B and input control signals for controlling the display thereof from an external graphics controller (not shown). The input image signals R, G, and B contain luminance information of pixels PX, and the luminance has a predetermined number of grays, for example 1024 (=2¹⁰), 256 (=2⁸), or 64 (=2⁶) grays. The input control signals include a vertical synchronization signal Vsync, a horizontal synchronization signal Hsync, a main clock signal MCLK, and a data enable signal DE.

On the basis of the input control signals and the input image signals R, G, and B, the signal controller 600 generates gate control signals CONT1 and data control signals CONT2 and it processes the image signals R, G, and B to be suitable for the operation of the panel assembly 300 and the data driver 500. The signal controller 600 sends the gate control signals CONT1 to the gate driver 400 and sends the processed image signals DAT and the data control signals CONT2 to the data driver 500.

When at least one register value of the first and second register units 601 and 602 is changed due to, for example, an electrostatic discharge or electrical shock applied from the outside, the register value adjuster 603 of the signal controller 600 initializes the register values of the first and second register units 601 and 602, to normally change the resister values to initial values. An operation of the register value adjuster 603 will be described in detail later.

The gate control signals CONT1 include a scanning start signal STV for instructing to start scanning and at least one clock signal for controlling the output period of the gate-on voltage Von. The gate control signals CONT1 may include an output enable signal OE for defining the duration of the gate-on voltage Von.

The data control signals CONT2 include a horizontal synchronization start signal STH for informing of start of data transmission for a row of pixels PX, a load signal LOAD for instructing to apply the data voltages to the data lines D₁-Dₘ, and a data clock signal HCLK. The data control signal CONT2 may further include an inversion signal RVS for reversing the polarity of the data voltages (relative to the common voltage Vcom).

Responsive to the data control signals CONT2 from the signal controller 600, the data driver 500 receives a packet of the digital image signals DAT for the row of pixels PX from the signal controller 600, converts the digital image signals DAT into analog data voltages selected from the gray voltages, and applies the analog data voltages to the data lines D₁-Dₘ.

The gate driver 400 applies the gate-on voltage Von to a gate line G₁-Gₙ in response to the gate control signals CONT1 from the signal controller 600, thereby turning on the switching transistors Q connected thereto. The data voltages applied to the data lines D₁-Dₘ are then supplied to the pixels PX through the activated switching transistors Q.

A difference between a data voltage and the common voltage Vcom applied to a pixel PX is represented as a voltage across the LC capacitor Clc of the pixel PX, which is referred to as a pixel voltage. The LC molecules in the LC capacitor Clc have orientations depending on the magnitude of the pixel voltage, and the molecular orientations determine the polarization of light passing through the LC layer 3. The polarizer(s) converts light polarization to light transmittance such that the pixel PX has a luminance represented by a gray of the data voltage.

By repeating this procedure by a unit of a horizontal period (which is also referred to as “1H” and is equal to one period of the horizontal synchronization signal Hsync and the data enable signal DE), all gate lines G₁-Gₙ are sequentially supplied with the gate-on voltage Von, thereby applying the data voltages to all pixels PX to display an image for a frame.

When the next frame starts after one frame finishes, the inversion signal RVS applied to the data driver 500 is controlled such that the polarity of the data voltages is reversed (which is referred to as “frame inversion”). The inversion signal RVS may also be controlled such that the polarity of the data voltages flowing in a data line are periodically reversed during one frame (for example, row inversion and dot inversion), or the polarity of the data voltages in one packet are reversed (for example, column inversion and dot inversion).

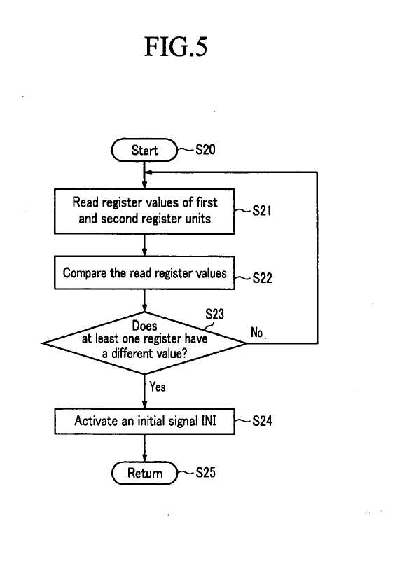

Referring to FIG. 5 as well as FIG. 3, the operation of the register value adjuster 603 of the signal controller 600 is described below in detail.

FIG. 5 is an operation flow chart of the register value adjuster 603.

When the operation of the register value adjuster 603 starts (step S20), the register value adjuster 603 reads register values of the first and second register units 601 and 602 (step S21).

At this time, the register value adjuster 603 reads values of first and second variable registers, of which values are arbitrary changed by a user, instead of reading all register values of the first and second register units 601 and 602. Thus, after the register value adjuster 603 reads the values of the first and second variable registers that are stored in corresponding addresses, the register value adjuster 603 compares the values of the first and second variable resisters stored in the same address, respectively (step S22).

Alternatively, when the constructions of the first and second register units 601 and 602 are different from each other, and thereby one of the first and second register units 601 and 602 includes fixed registers, and the first and second variable registers, and the other of them includes the first and second variable registers, the register value adjuster 603 compares values of the first and second variable registers of the first and second register units 601 and 602.

At this time, when at least one register of the first and second variable registers stored in the same address has a different value (step S23), the register value adjuster 603 activates an initial signal INI, for example, from a low level voltage L to a high level voltage H, to transmit it to the P&P unit 620 (step 24).

Thereby, the P&P unit 620 outputs the shutdown signal SD having a high level voltage H for a predetermined time and then changing to a low level voltage L in response to the activated initial signal INI, to transmit it to the first and second register units 601 and 602.

When the state of the shutdown signal SD is changed from the high level voltage H to the low level voltage L, the first and second register units 601 and 602 initialize the register values thereof with predetermined initial values.

Thereby, when the values of the first and second variable registers are changed due to the electro static discharge or the electrical shock, the register values of the first and second register units 601 and 602 are recovered to the initial values by the shutdown signal SD.

However, when all registers of the first and second variable registers stored in the same address have the same values (step S23), respectively, the register value adjuster 603 goes to step (S21), to compare the register values of the first and second register units 601 and 602.

As described above, since instead of the comparison of all register values of the first and second register units 601 and 602, the values of the first and second variable registers are compared to each other, processing time of the register value adjuster 603 decreases and the construction thereof is simplified.

In this embodiment, for determining change of the register values of a register unit due to the electrostatic discharge or the electrical shock, one separate register is added, but two or more separate registers may be added to improve reliability of the operation of the register value adjuster 603.

According to the embodiment, when register values of a register unit are changed due to electrostatic discharge and electrical shock a state of a shutdown signal output from the P&P unit is controlled without regard to the operation of the P&P unit, and thereby a state of the register unit is initialized. Thus, the changed register values are normally recovered to initial values, to normally display images in an LCD.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving apparatus comprising:
a signal generator adapted to generate a shutdown signal;
a plurality of register units adapted to store register values;
a register value adjuster operative to compare register values at an address in each of the plurality of register units, and when at least one register value stored in the same address in each of the plurality of register units is different, the register value adjuster controls a state of the shutdown signal,
wherein an initialization of the register values stored in the register units is controlled based on the shutdown signal.

2. The driving apparatus of claim 1, wherein the signal generator is a plug and play unit.

3. The driving apparatus of claim 1, wherein the register units comprise a first register unit and a second register unit.

4. The driving apparatus of claim 3, wherein the circuitry of first register unit and the circuitry of second register unit are the same.

5. The driving apparatus of claim 3, wherein the register value adjuster compares the register values stored in the same address in at least one part of the first and second register units, and when at least one of the compared register values is different, controls a state of the shutdown signal to initialize the register values of the first and second register units.

6. The driving apparatus of claim 5, wherein the first and second register units store values of a fixed register and a variable register, and the values of the fixed register are not changed but the values of the variable register are changed.

7. The driving apparatus of claim 6, wherein the register value adjuster compares the values of the variable register of the first register unit and the values of the variable register of the second register unit.

8. The driving apparatus of claim 1, wherein the register units comprise: a first register unit that stores register values of a fixed register and register values of a variable register, and a second register unit that stores register values of the variable register.

9. The driving apparatus of claim 8, wherein the register value adjuster compares the register values of the variable register of the first register unit and the register values of the variable register of the second register unit.

10. A driving apparatus for a display device having a plurality of pixels, the driving apparatus comprising:
a signal generator adapted to generate a shutdown signal;
a plurality of register units adapted to store register values;
a gate driver that transmits gate signals to the pixels;
a data driver that transmits data voltages to the pixels; and
a signal controller that controls the gate driver and the data driver based on the register values of the register units,
wherein an initialization of the register values stored in the register units is controlled based on the shutdown signal.

11. The driving apparatus of claim 10, wherein the register units comprise a first register unit and a second register unit.

12. The driving apparatus of claim 11, wherein the first and second register units store values of a fixed register and a variable register, and the values of the fixed register are not changed but the values of the variable register are changed.

13. The driving apparatus of claim 10, wherein the register units comprise: a first register unit that stores register values of a fixed register and register values of a variable register, and a second register unit that stores register values of the variable register.

14. The driving apparatus of claim 10, wherein the register value adjuster compares the register values stored in the same address in at least one part of the first and second register units, and when the compared register values are different, controls a state of the shutdown signal to initialize the register values of the first and second register units.

15. A driving method of a display device having a plug and play unit that generates a shutdown signal, and a plurality of register units, the driving method comprising:
reading register values stored in at least one part of the register units;
comparing the read register values stored in the same address; and
changing a state of the shutdown signal when an address having a different register value from each other exists, to initialize the register values of the register units with initial values.
